(19) United States
(12) Patent Application Publication
(10) Pub. No.: US 2003/0127493 A1
(43) Pub. Date: Jul. 10, 2003

(54) PURGE GAS WELDING RING

(76) Inventor: David Ciriza, Wheatridge, CO (US)

Correspondence Address: Scott L. Terrell, P.C., Ste. 225, 1746 Cole Blvd., Golden, CO, 80401, US

(21) Appl. No.: 10/038,088

(22) Filed: Jan. 7, 2002

(51) Int. Cl. B23K 20/08; B23K 20/14

(52) U.S. Cl. 228/42; 228/33; 228/219

(57) ABSTRACT

A purge ring is provided for supplying a shield gas to the root side of a tubular article to be welded. The purge ring includes a generally U-shaped split-cylindrical body having an adjustable circumference together with slotted side walls connected by a bottom wall, the slotted side and bottom walls defining an isolation zone and a slip joint for insertion or retrieval of the purge ring in relation to the tubular article to be welded.

### CROSS REFERENCE TO RELATED APPLICATIONS

Not Applicable.

### BACKGROUND OF THE INVENTION

1. Field of the Invention.

The present invention relates to the field of welding. In particular, it relates to an apparatus for shielding the root side of a weld seam of a tubular article to be welded.

2. Description of the Related Art.

In TIG welding of a tubular work piece it is conventional to establish an inert atmosphere at the root side which is inside the tubular article at the weld seam. Without an inert atmosphere, the interior surface of the welded joint is subject to oxidation, other impurities and incomplete fusion of the pipe edges.

A conventional practice involves filling an entire pipe line with a protective gas, such as argon, and providing a continuous flow of argon gas throughout the welding operation. A recognized draw back of this practice is that it consumes large amounts of costly argon gas.

Numerous patents disclose methods to be used as intended alternatives to the continuous flow method. These patents disclose the use of purge blocks, dams or plugs, which establish a localized inert atmosphere at the root of the work piece to be welded. Examples of such patents include U.S. Pat. Nos. 5,398,863; 5,187,343; 5,126,526; 3,095,844, and numerous others.

While the aforementioned patents provide shielding of a section of a workpiece, there is still a need for an apparatus which provides an effective shielding inert gas atmosphere in the inside of a tubular workpiece at the weld seam. The present invention satisfies this need.

### BRIEF SUMMARY OF THE INVENTION

It is therefore a principal object of the present invention to provide an apparatus for supplying an inert gas shielding atmosphere in the inside of a tubular work piece point of the weld seam.

It is another object of the present invention to provide such an apparatus which is simple, timely, and reliable in manufacture and use.

It is another object of the present invention is to provide such an apparatus which is readily adaptable to the fabrication of tubular networks having fittings and curved sections.

It is another object of the present invention to provide such an apparatus which is readily adaptable for use with tubular stainless steel, chrome and other materials.

It is another object of the invention to provide such an apparatus which consumes a least amount of inert gas in operation.

It is yet another object of the present invention to provide such an apparatus which readily locates against inner walls of the tubular work piece and evenly aligns an equal distance about the inside the root of the weld seem.

To overcome the problems of the prior art methods and in accordance with the purpose of the invention, as embodied and broadly described herein, briefly, a purge ring is provided for supplying a shield gas to the root side of a tubular article to be welded. The purge ring includes a split-cylindrical body having an adjustable circumference, said body having first and second annular side walls disposed in a spaced relation to each other and connected by a bottom wall, the side walls and bottom walls having first and second ends slidably bearing against each other defining a slip joint means for adjustment of the circumference and each side wall further comprising a plurality of open slots, each open slot defined by first and second edges radially extending to an outer periphery of the side wall, a plurality of side wall caps each having an inner surface and at least three sides wherein the inner surface of each cap is connected at a first side to an outer surface of the side wall at a point adjacent to the first slot edge, whereby the inner surface of each cap overlaps the open slot and slidably bears against the outer surface of the side wall at a point adjacent the second slot edge, an annular isolation zone intervening the side walls and side wall caps, a means for supplying a shield gas to the isolation zone, and a means for insertion or removal of the purge ring in relation to the tubular article to be welded.

Additional advantages of the present invention will be set forth in part in the description that follows and in part will be obvious from that description or can be learned from practice of the invention. The advantages of the invention can be realized and obtained by the apparatus particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the invention and, together with the description, explain the principles of the invention.

FIG. 1 is a front view of the inert gas purge ring assembly according to the present invention.

FIG. 2 is a side view of the embodiment shown in FIG. 1.

FIG. 3 is a cross sectional view along the line 3-3 of FIG. 2.

FIG. 4 is a cross section of the present invention along the line 4-4 of FIG. 2.

FIG. 5 is a cross section along the line 5-5 of FIG. 2 showing positioning of the dial pin sleeves for receiving dial pins used for positioning the apparatus evenly about the interior of the weld seam.

FIG. 6 shows the present invention is its compressed position for retrieval from a tubular article once shielding is no longer needed.

FIG. 7 shows a perspective view of the present invention.

FIG. 8 shows an alternative embodiment of the present invention.

FIG. 9 shows a cross section of a tube end and a tube bend with a referred location of the apparatus.

FIG. 10 shows an cross section of a tube flange and a tube bend with a preferred location of the apparatus.

FIG. 11 shows a cross section of the present invention as properly aligned using the dial pins for evenly positioning the device about the interior of the weld seam, between two sections of pipe.

### DETAILED DESCRIPTION OF THE DRAWINGS

Unless specifically defined otherwise, all technical or scientific terms used herein have the same meaning as commonly understood by one of ordinary skill in the art to which this invention belongs. The invention operates to provide an apparatus for supplying an inert gas shielding atmosphere in the inside of a tubular work piece at the point of the weld seam. Thus, certain physical principles of welding are discussed herein solely as an aid, and not by way of limitation, to further an explanation of the invention.

Although any methods and materials similar or equivalent to those described herein can be used in the practice or testing of the present invention, the preferred methods and materials are now described. Reference now will be made in detail to the presently preferred embodiments of the invention, examples of which are illustrated in the accompanying drawings.

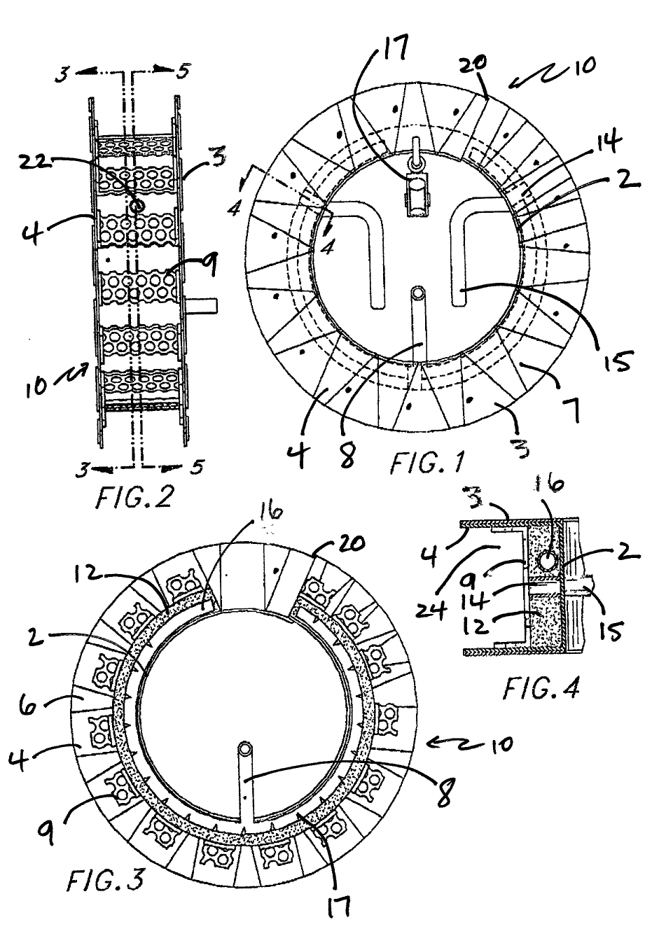

Referring now to the drawing figures, wherein like numerals represent like features, it is generally shown in FIGS. 1 and 2 a front and side view, respectively, of the preferred embodiment of the apparatus 10. As shown in the Figures, apparatus 10 has two annular slotted side walls 4. The slots (not shown in FIG. 1) are preferably V-shaped tapering radially and outwardly from the bottom wall 2 to an outer periphery of the side walls 4.

The side walls 4 are each joined by a semi rigid bottom wall 2 to provide an intervening structure between the side walls 4. Side walls 4 that are so joined generally define a substantially U-shaped member wherein the arms of the U are corresponding side walls 4, and the bottom of the U is arranged substantially about a central axis. In the preferred embodiment, the entire U shaped arrangement may be readily assembled for use by forming a single rectangular sheet of stainless steel into a U shape by folding the side walls 4 upwardly, cutting out the tapered slots in the side walls 4, rolling the sheet in to a ring, and slightly bending two corresponding edges of the side walls 4 inwardly so as to form the slip joint 20. This configuration enables the apparatus to have an adjustable circumference whereby the inner diameter of the tubular article to be welded is within the circumferential elastic working range of the apparatus 10.

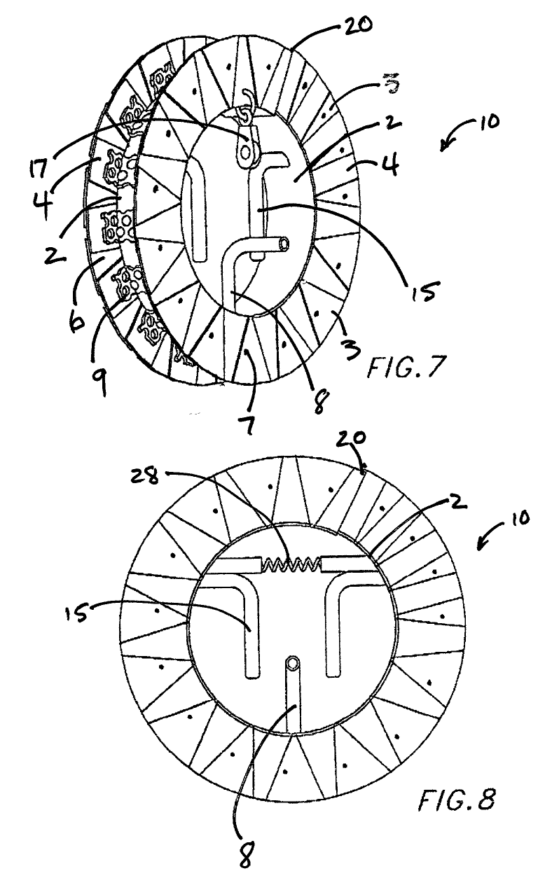

Skipping now to FIG. 7, where a perspective view of the apparatus 10 is illustrated, tapered open V-shaped slots 6 in each side wall 4 are cutout so as to taper radially and outwardly from the bottom wall 2 to the outer periphery of each side wall 4. The open slots 6 of each side wall 4 are alternating between solid wall 6 segments so as to allow an expandable and contractible circumference of apparatus 10 at the slip joint 20. Overlapping the open slots 6 are a plurality of preferably triangular caps 3 fastened 7 at one edge to the outer surface of the side wall 4 adjacent to an edge of the slot 6. Fastening is preferably made using a spot weld 7, but other means such as a rivet or threaded fastener may also be used. In this manner the caps 3 are arranged adjacent to and offset from the outer surfaces of the side walls 4. This alternating overlapping arrangement of caps 3 and solid wall sections allows the side walls 4 to remain as a substantially single annular solid wall throughout the expansion and compression of the apparatus 10 for insertion and removal from the interior walls of the tubular article to be welded.

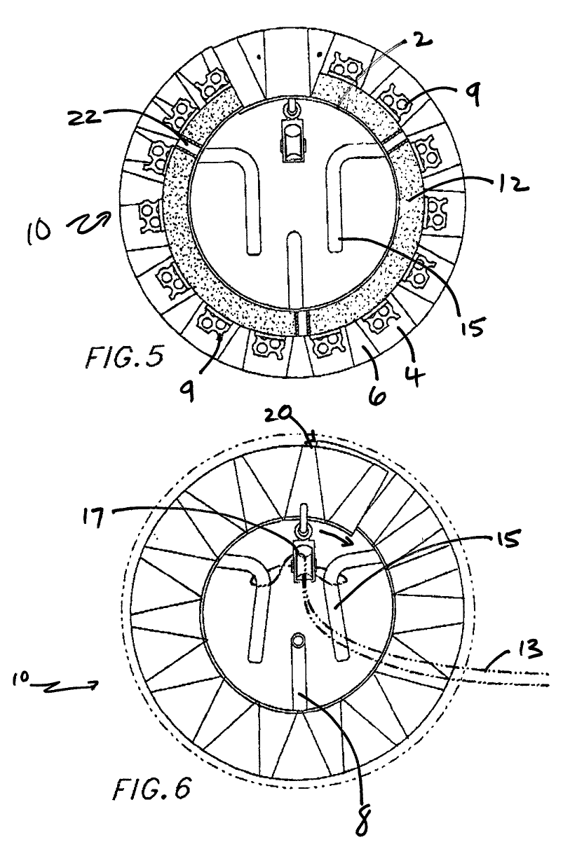

Inert gas may be fed to the space between side walls 4, that is, into the isolation zone 24 established between side walls 4 and bottom wall 2 within the tubular article to be isolated by the apparatus 10, through any desired means such as, for example, a conduit 8 passing through the bottom wall 2. It should also be noted that the apparatus 10 may also be retracted from a tubular member by compressing apparatus 10 at slip joint 20 either by squeezing handles 15 together, by hand, or compressing handles 15 together using a line 13 forming a loop around both handles 15 and threaded through a pulley assembly 17, as illustrated in FIG. 6, with the operator pulling on the ends of the line 13 to retrieve apparatus 10.

FIG. 4 illustrates a cross section 4-4 of FIG. 1. In the Figure, a gas dispersion medium 12, such as a stainless steel wool, is packed about an annular gas dispersion manifold 16 and firmly against bottom wall 2. The dispersion medium 12 is preferably secured in place using a plurality of U-shaped corrugated retaining clips 9, each clip 9 securely fastened to the inner surface of side walls 4 at the arms of the U-shape by means of a weld, rivet, or threaded fastener. Handles 15 are securely fastened through 14 the bottom wall 2 preferably by means of a weld. Isolation zone 24 is created between bottom 2, side walls 4 and clips 3.

FIG. 3 illustrates a cross section 3-3 of FIG. 2 through the manifold 16. Pipe branch gas supply conduit 8 is desirably arranged to pass through the bottom wall 2 of the apparatus 10 and connects with an annular gas dispersion manifold 16. The gas dispersion manifold 16 is preferably tubular, approximately 3.18 mm in diameter, and includes a plurality of evenly arranged open slots 16 about its outer periphery, for even distribution of an inert gas into the isolation zone 24.

FIG. 5, cross section 5-5 of FIG. 2, shows the dispersion medium 12 and dial pin sleeves 22. The dispersion medium 12 is located between the bottom wall 2 and corrugated retaining clips 9. The dial pin sleeves 22 preferably pass around the dispersion medium 12 and are used to receive dial pins (not shown) which, when inserted through a weld seam and into the sleeves 22, hold the apparatus 10 securely and evenly in place during operation.

FIG. 6 illustrates the manner within which the apparatus 10 may, but need not, be contracted and retrieved using a rope and pulley assembly 13, 17. This is particularly useful when locating the apparatus 10 in tubular members longer than 0.9 meters, or through a series of bends including: a 90°; 45°; or Tee's. Here, a loop in line 13 is located around each of the handles 15 and the ends of the line 13 are threaded over the pulley wheel of pulley assembly 17. In this manner, the operator simply pulls on the ends of line 13 which causing compression of the apparatus 10, at slip joint 20, and a corresponding reduction in circumference of apparatus 10 (from dashed line) for easy retrieval after operation or when a shielding atmosphere is no longer needed.

FIG. 8 illustrates an alternate embodiment of the invention wherein apparatus 10 further includes a spring means 28, such as a helical coil, attached to the bottom wall 2 of the apparatus 10 for contracting the circumference of apparatus 10 at slip joint 20. The spring 28 aids in hand retrieval of the apparatus 10 when used in welding shorter sections of pipe.

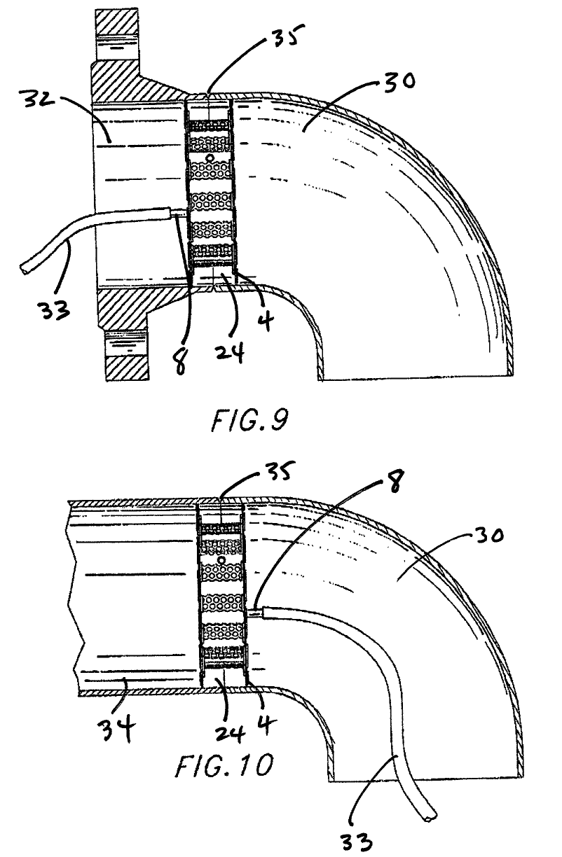

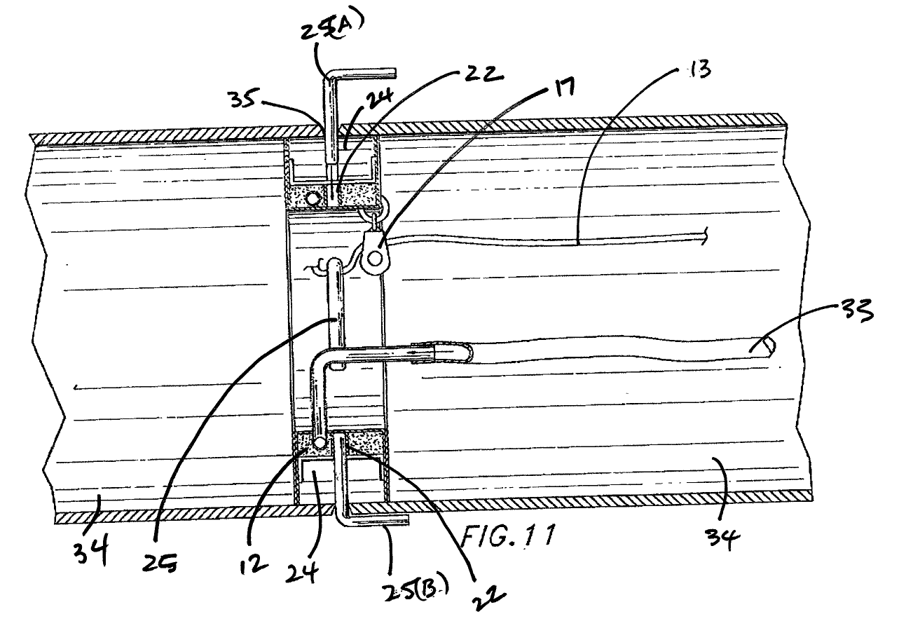

FIGS. 9 and 10 illustrates location of apparatus 10 is when the operator is performing a weld on a fitting or a bend, respectively. Once assembled, apparatus 10 is then, according to the invention, disposed within a tubular work piece having a fitting 32 or easily having a bend 30 in a position wherein the side walls 4 are arranged an equal distance, preferably approximately 19 mm, at either side of the weld seam 35. The bottom wall of apparatus 10 is constructed of sufficiently semi-rigid materials, such as twenty-two to twenty-six gauge stainless sheet metal, so that, when rolled into a cylinder, a spring load provides a sufficient contact force for expanded bias of side walls 4 against the inner walls of the tubular work pieces 32, 30 and 34, 33, thereby providing a substantially isolated zone 24 into which inert gas can be introduced, for example by means of gas supply line 33 and conduit 8, so as to provide a substantially inert shielding atmosphere at the root side of the weld seam 35.

FIG. 11 shows how the apparatus is easily used. Initially the apparatus is located within the inner walls of pipe sections 34 and centered evenly at the weld seam 35. To center and hold apparatus 10 in position during the welding operation, three dial pins 25 are easily inserted 25(b) through the weld seam 35 and into the dial pin sleeves 22. A supply of shielding gas, such as compressed argon, is fed through supply hose 33, conduit 8, and manifold 16 where it replaces the atmosphere in the isolation zone with the desired shielding gas. Prior to welding, dial pins 25 are removed. Once welding has been completed, and/or shielding is no longer necessary, the apparatus 10 is retrieved from the work piece 34, 34 preferably using line 13 and pulley assembly 17, as discussed above.

While the present invention has been described in connection with the illustrated embodiments, it will be appreciated and understood that modifications may be made without departing from the true spirit and scope of the invention.

I claim,

1. An purge ring for providing a shield gas to the root side of a tubular article to be welded, comprising:
(a) a split-cylindrical body having an adjustable circumference, said body having first and second annular side walls disposed in a spaced relation to each other and connected by a bottom wall, the side walls and bottom walls having first and second ends slidably bearing against each other defining a slip joint means for adjustment of the circumference and each side wall further comprising a plurality of open slots, each open slot defined by first and second edges radially extending to an outer periphery of the side wall;
(b) a plurality of side wall caps each having an inner surface and at least three sides wherein the inner surface of each cap is connected at a first side to an outer surface of the side wall at a point adjacent to the first slot edge, whereby the inner surface of each cap overlaps the open slot and slidably bears against the outer surface of the side wall at a point adjacent the second slot edge;
(c) an annular isolation zone intervening the side walls and side wall caps;
(d) a means for supplying a shield gas to the isolation zone; and
(e) a means for inserting or removing the purge ring in relation to the tubular article to be welded.

2. The purge ring according to claim 1 wherein the supply means comprises a pipe branch radially extending through the bottom wall into the isolation zone and connecting to a annular exhaust gas manifold having a plurality of outlets for releasing the shield gas in to the isolation zone.

3. The purge ring according to claim 1 wherein the insertion and removal means comprises at least one handle connected to the bottom wall.

4. The purge ring according to claim 1 wherein the insertion and removal means comprises at least one handle or a handle and pulley assembly connected to the bottom wall.

5. The purge ring according to claim 1 further comprising a means for centering the purge ring evenly about the root side of the weld.

6. The purge ring according to claim 2 wherein the supply means further comprises a dispersion medium packed about the annular exhaust manifold and a means for retaining the dispersion medium adjacent to the exhaust manifold.

7. The purge ring according to claim 5 wherein the means for centering comprises a plurality of dial pin sleeves rigidly connected to the bottom wall an equal distance between the side walls and radially extending into the isolation zone for removable insertion of the dial pins through a weld seam.

8. The purge ring according to claim 6 wherein the dispersion medium is a metallic wool and the retaining means comprises a plurality of U-shaped corrugated metallic clips biased against the metallic wool and connected to the side walls.

9. An purge ring for providing a shield gas to the root side of a tubular article to be welded, comprising:
(a) a split-cylindrical body having an adjustable circumference, said body having first and second annular side walls disposed in a spaced relation to each other and connected by a bottom wall, the side walls and bottom walls having first and second ends slidably bearing against each other defining a slip joint means for adjustment of the circumference and each side wall further comprising a plurality of open slots, each open slot defined by a V-shape having first and second edges tapering radially and outwardly to an outer periphery of the side wall,
(b) a plurality of triangular side wall caps each having an inner surface and at least three sides wherein the inner surface of each cap is connected at a first side to an outer surface of the side wall at a point adjacent to the first slot edge, whereby the inner surface of each cap overlaps the open slot and slidably bears against the outer surface of the side wall at a point adjacent the second slot edge;
(c) an annular isolation zone intervening the side walls and side wall caps;
(d) a shield gas supply assembly comprising a pipe branch radially extending through the bottom wall into the isolation zone and connecting to a annular exhaust gas manifold having openings for releasing the shield gas into the isolation zone, a metallic wool dispersion medium packed about the annular exhaust manifold, and a plurality of U-shaped corrugated metallic clips biased against the metallic wool and connected to the side walls for retaining the metallic wool adjacent to the exhaust manifold and bottom wall;
(e) at least one handle or a handle and pulley assembly connected to the bottom wall for insertion or removal of the purge ring in relation to the tubular article to be welded; and
(f) a plurality of dial pins sleeves each rigidly connected to the bottom wall an equal distance between the side walls and radially extending into the isolation zone for removable insertion of a dial pin through a weld seam.
